(19) United States
(12) Patent Application Publication
(10) Pub. No.: US 2009/0181193 A1
(43) Pub. Date: Jul. 16, 2009

(54) PROCESS FOR THE CONTINUOUS PRODUCTION OF MESH BAGS

(75) Inventor: Ezequiel GIRO AMIGO, Badalona (ES)

Correspondence Address: SUGHRUE MION, PLLC, 2100 PENNSYLVANIA AVENUE, N.W., SUITE 800, WASHINGTON, DC, 20037, US

(73) Assignee: GIRO GH, S.A., Badalona (ES)

(21) Appl. No.: 12/349,992

(22) Filed: Jan. 7, 2009

(30) Foreign Application Priority Data
Jan. 14, 2008 (ES) P 200800078

(51) Int. Cl. B32B 1/08; B32B 37/00; B32B 3/00

(52) U.S. Cl. 428/35.2; 156/64; 428/199

(57) ABSTRACT

The present invention relates to a process for the continuous production of mesh bags, comprising the operation of cutting longitudinal portions from a body of bag formed by a longitudinal section of flattened tubular mesh and a longitudinal section of at least one flexible sheet applied and attached to one of the faces of said tubular mesh, in which prior or subsequent to the application of the sheet on the mesh said sheet is passed through detection means, suitable for detecting the passage through the detection field of a section of sheet provided with a marking, transparent to visible light and luminescent upon being radiated with ultraviolet or infrared light. The detection of said marking automatically triggers the performance of the operation of transversely cutting the continuous body of bag into a length corresponding to that of a bag.

### TECHNICAL FIELD OF THE INVENTION

The invention relates to a process for the continuous production of mesh bags, comprising the operation of cutting longitudinal portions from a body of bag formed by a longitudinal section of flattened tubular mesh and a longitudinal section of at least one flexible sheet, longitudinally applied and attached to one of the faces of said flattened tubular mesh. The invention also relates to a sheet suitable for carrying out the process and a mesh bag obtainable by means of the mentioned process.

### BACKGROUND OF THE INVENTION

For the manufacture of mesh bags intended to contain preferably fruit and vegetable products, the manufacturing process is known in which said bags are produced from longitudinal portions from a continuous body of bag formed by a longitudinal section of flattened tubular mesh and a longitudinal section of at least one flexible sheet, longitudinally applied and attached to one of the faces of said flattened tubular mesh.

By way of example, patents EP1481899 B1 and WO03011692 describe respective processes and machines for the manufacture of bags formed from a tubular mesh, in which said machines are fed by a long roll of continuous tubular mesh. These machines open a portion of tubular mesh and on one or on both sides of said portion of tubular mesh apply respective sheets of plastic material laterally covering the mesh, which are fed from respective long reels of continuous sheet, to form the continuous body of bag mentioned above.

In each operation cycle of a machine of this type, an end portion of the continuous body of bag, formed by the mesh and the sheet or sheets applied on it, is cut, the length of said portion being approximately that of the bag to be produced, and the end of the rest of the continuous body of bag is closed, transversely joining the sheets by heat-sealing. The machine then separates the longitudinal portion obtained, forming an individual bag open at its mouth and closed at its bottom, which is transferred to subsequent and successive stations for the filling and closure of its mouth.

These sheets are normally used as support for printing information, illustrations or instructions related to the stored product. In order for these prints to be well positioned on each one of the bags, or in order for the length of all the bags to be the same, the machines incorporate a device halting the automatic advance both of the continuous body of bag and of the rolls of the mesh and sheet from which said continuous body of bag is obtained by means of the optical detection of visible markings from the outer face of at least one of the two sheets. It is then that the transverse cutting operation of the continuous body of bag is carried out.

Once this cutting operation has been carried out, a new bag is produced from the continuous body of bag, which will be transversely cut when a new visible marking is detected in any one of the sheets supplied to form the continuous body of bag.

On occasions, the sheets contain similar or complementary information and the case of such information not being well adjusted or coinciding once the bag has been finished can occur due to the fact that a sheet has been dragged through the rollers for a length different from the length that the other sheet has been dragged.

Furthermore it is also common for the mesh to suffer some type of deformation and that one of its faces and the corresponding sheet suffers a movement with respect to the other face and corresponding sheet, which further increases the possibility that a sheet advances a length greater than its similar sheet. This effect also causes the final finish of the bags to not be satisfactory.

For that purpose, some machines incorporate devices to correct the involuntary offsets occurring during the dragging of the sheets or of the body of bag formed without need to stop the machine. These devices are also based on detecting the visible markings with which the sheets are provided. A method for correcting an offset of this type is described in patent document EP1627728 B1.

Such optically detectable markings have the serious drawback that they are easily confused with other adjacent marks, instructions or markings and can produce errors in the stopping and subsequent cutting, therefore a large part of any mark or marking that could produce such errors must be separated. This implies that they noticeably stand out in the external appearance of the bag and give rise to aesthetically undesired effects, which results in important advertising and/or commercial damage. In the same way, the design of the printed illustrations on the band is highly conditioned by the need to prevent some parts of these illustrations from being confused with the markings triggering the automatic cutting of the mesh.

In addition, when for any reason the user of the machine disconnects the markings detector device and voluntarily changes the length of the bags, for example to increase their capacity, the separation between every two markings of the sheets does not coincide with said new length, whereby the markings appear on the bags in different positions, as the operation cycles are carried out, substantially changing the appearance of the bags.

### DISCLOSURE OF THE INVENTION

The process according to the invention is of the type comprising the operation of cutting longitudinal portions from a body of bag formed by a longitudinal section of flattened tubular mesh and a longitudinal section of at least one flexible sheet longitudinally applied and attached to one of the faces of said flattened tubular mesh.

Said process is essentially characterized in that, prior or subsequent to its application on the mesh, the flexible sheet is passed through detection means; in that said flexible sheet is provided with a plurality of markings distributed along its length, transparent to visible light and luminescent upon being radiated with ultraviolet or infrared light; in that the detection means are suitable for emitting ultraviolet or infrared light to detect the passage through the detection field of a section of flexible sheet provided with one of the markings; and in that the detection of one of said markings automatically triggers the performance of the operation of transversely cutting the continuous body of bag into a length corresponding to that of a bag.

The process is applicable regardless of the method used for the formation of the body of bag that is subsequently cut, including the possibility that the mentioned tubular mesh is formed from a flat mesh the longitudinal edges of which are attached to form said tubular mesh. In this specific case, the process according to the invention contemplates the possibility that the flexible sheet or sheets are applied and attached to the flat mesh, prior to its longitudinal edges being attached to obtain the body of bag according to the preamble of claim 1.

In a variant of the process, the body of bag comprises two flexible sheets, longitudinally applied on respective faces of the flattened tubular mesh, both sheets are provided with a plurality of markings distributed along their length, transparent to visible light and luminescent upon being radiated with ultraviolet or infrared light and both sheets are passed through the detection field of respective detection means.

According to another feature of this variant of the invention, the distribution of the markings along one of the sheets is different from the distribution of the markings along the other sheet.

According to another feature of the process, the detection means are suitable for distinguishing among the detected markings those corresponding to a predetermined or pre-programmed pattern, said markings being the only ones automatically triggering the performance of the operation of transversely cutting the body of bag.

According to a variant of the invention, in at least one of the sheets the markings are distributed in series, the markings of each series being equal, equidistant from one another and differentially detectable with respect to the markings of the other series.

These features advantageously allow the manufacturer to be able to choose from more than one length of bag without having to change the sheet or the sheets that are applied to the sides of the tubular mesh. The user can programme the machine by pre-selecting the markings triggering with their detection the transverse cutting, being able to choose for that the marking of any one of the series of markings. Although the markings of the rest of the series are located in a central position of the bag, they do not detract from the finish of the bags due to being transparent to visible light.

Furthermore, the manufacturer can choose from more than one length of bag without sacrificing the precision that can be obtained when the cutting order is made, automatically, by detecting a marking provided for that purpose in the sheet or sheets. Until now, if the manufacturer disconnected the detection means for detecting the markings to voluntarily change the length of the bags, he or she sacrificed the precision that such markings conferred.

According to another aspect of the invention, a mesh bag obtainable according to the process of any one of the previous claims is disclosed, in which bag, being formed from a longitudinal section of flattened tubular mesh and a longitudinal section of at least one flexible sheet longitudinally applied and attached to one of the faces of said flattened tubular mesh, said flexible sheets are provided with markings distributed along their length, transparent to visible light and luminescent upon being radiated with ultraviolet or infrared light.

According to another aspect of the invention, a flexible windable sheet is disclosed, applicable for making transpirable bags, such as mesh bags, and according to the process of the invention. Said sheet is essentially characterized in that it comprises a plurality of markings, distributed along its length, transparent to visible light and luminescent upon being radiated with ultraviolet or infrared light.

Upon passing the sheet through the detection field of a detector, the detection of said markings can automatically trigger the operations of stopping and subsequent transverse cutting of an assembly formed by a section of flattened tubular mesh and a longitudinal section of at least one flexible sheet longitudinally applied and attached to one of the faces of said flattened tubular mesh being carried out in the manufacture of this type of bag.

According to a variant of interest of said sheet, the markings are distributed in one or several series, the markings of each series being equal, equidistant from one another and differentially detectable with respect to the markings of the other series.

### BRIEF DESCRIPTION OF THE DRAWINGS

Different variants of the process, of longitudinal portions of a body of bag obtainable according to said process and of a sheet particularly suitable for carrying out said process according to the invention are shown in the attached drawings by way of non-limiting example. Specifically,

FIGS. 1 and 2 are schematic depictions of two variants of the process according to the invention;

FIGS. 3 and 4 are depictions of longitudinal portions of respective bodies of bag obtainable by following the process of the invention;

FIG. 5 is a perspective view of a reel of a sheet according to the invention;

FIG. 6 shows a plan view of a section of sheet according to the invention; and

FIG. 7 is a depiction of a full mesh bag.

### DETAILED DESCRIPTION OF THE DRAWINGS

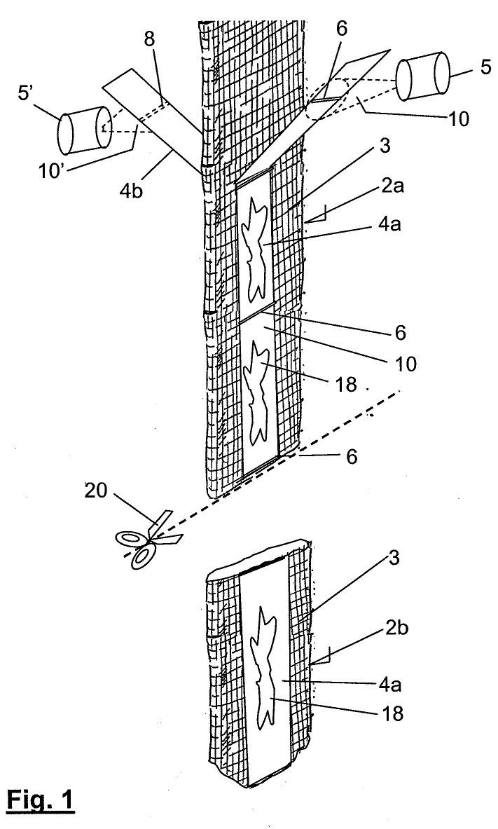

FIG. 1 schematically depicts a variant of the process according to the invention. The process comprises first the operation of forming a body of bag 2a, formed by a longitudinal section of flattened tubular mesh 3 and two longitudinal sections of respective flexible sheets 4a and 4b each one longitudinally applied and attached to a corresponding face of said flattened tubular mesh 3, and subsequently the operation of cutting longitudinal portions 2b from said body of bag 2a. Each one of the flexible sheets 4a and 4b is provided with a plurality of markings 6 and 8, respectively, transparent to luminous radiations within the spectrum visible to the human eye, suitably distributed along its length and suitable so that, upon being radiated with ultraviolet light, they emit a luminescent reflection capable of actuating a sensor that starts, by way of example, a transverse cutting mechanism 20 for cutting the body of bag 2a.

In the variant depicted, the separation between every two markings 6 and between every two markings 8 is the same and corresponds to the approximate length of the bags 1 that are to be made.

According to this variant, the body of bag 2a is obtained for example from a continuous roll of tubular mesh 3 and from two continuous rolls of respective flexible sheets 4a and 4b. The following process can be performed to apply each of the sheets 4a and 4b on one of the faces of the tubular mesh 3:

supplying and perimetrically expanding a section of tubular mesh 3 such that the latter adopts an essentially rectangular cross-section in which two opposite sides are distinguished; and

supplying respective sections of flexible sheets, facing them and attaching them longitudinally to the expanded tubular mesh, each one on one of the opposite sides of the expanded section of tubular mesh.

Naturally, and in relation to the tubular mesh 3, it can be said that the latter can be obtained prior to its attachment to the sheets 4a and 4b from a flat mesh.

Alternatively to the variant shown, the body of bag 2a can be prepared or formed beforehand, being able to be stored wound around a reel core, and be supplied to carry out the cutting operation.

The possibility that the sheets 4a and 4b are applied and are attached to a flat mesh the longitudinal edges of which are subsequently attached to form a body of bag suitable for carrying out the process according to the invention is also contemplated.

In any case, the process comprises the operation of cutting longitudinal portions 2b from a body of bag 2a formed by a longitudinal section of flattened tubular mesh 3, regardless of the method of obtaining it, and a longitudinal section of at least one flexible sheet 4a or 4b, longitudinally applied and attached to one of the faces of said flattened tubular mesh 3. In this sense, and despite the fact that only one variant has been depicted in which there are two sheets forming the body of bag 2a together with the tubular mesh 3, it can be said that the described process is also applicable in the event that there is only one sheet, the one applied on the flattened tubular mesh 3.

For the purpose of automating the cutting operation, in the variant of the process depicted in FIG. 1, prior to their application on the tubular mesh 3, the flexible sheets 4a and 4b are passed through respective detection means 5 and 5′. Said detection means 5 and 5′ are suitable for emitting ultraviolet or infrared light and for detecting the passage through their detection fields 10 and 10′ of a section of flexible sheet 4a and 4b provided with one of the markings 6 or 8. The detection of one of said markings 6 or 8 automatically triggers the performance of the operation of transversely cutting the continuous body of bag 2a into a length corresponding to that of a bag. The cutting mechanism 20, which is schematically depicted, is arranged downstream from the detection means 5 and 5′.

In the case of a previously made continuous body of bag 2a being supplied, a variant which is not shown, the body of bag 2a formed by the tubular mesh 3 and the sheets 4a and 4b attached to it would be passed through detection means, not depicted, similar to the detection means 5 and 5′ shown in FIG. 1, suitable for emitting ultraviolet or infrared light and for detecting the passage through their detection field in this case of a section of the body of bag 2a one of the associated sheets 4a or 4b of which is provided with one of the markings 6 or 8, the detection of one of said markings triggering the automatic performance of the operation of transversely cutting the continuous body of bag 2a into a length corresponding to that of a bag 1.

Although it is not depicted, the process according to the invention can be applied even when the detection means are situated downstream from the meeting point of the sheets 4a and 4b with the tubular mesh 3. In this case, and as in the variant in which a previously made continuous body of bag 2a is supplied, the body of bag 2a, formed by the tubular mesh 3 and the sheets 4a and 4b attached to it, would be passed through detection means similar to the detection means 5 and 5′ depicted in FIG. 1.

It should be mentioned that the detection of the markings 6 and 8 provided on the sheets 4a and 4b can be used to correct differences in the supply, generally by dragging by means of rollers, of said sheets 4a and 4b.

The sheets 4a and 4b also serve for printing images 18, identifying data of the bag, its content or advertisements, which can contain similar or complementary information in the two sheets 4a and 4b applied on the two faces of the tubular mesh 3. In this case, the information of one of the sheets might not agree with that of other, once the bag 1 has been finished, due to the fact that one sheet has been dragged by the rollers for a different length than the other one.

For the purpose of manufacturing bags with different sizes without needing to change the sheets 4a and 4b for other sheets the markings 6 and 8 of which, respectively, are separated by a distance different from that depicted in FIG. 1, it is envisaged that the markings are distributed in series, the markings of each series being equal, equidistant from one another and differentially detectable with respect to the markings of the other series.

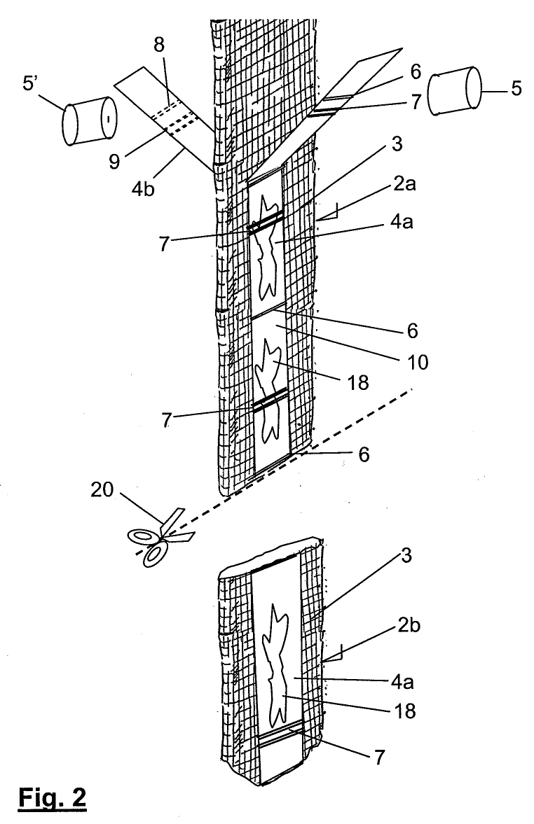

Thus, in the variant of the process depicted in FIG. 2, the sheet 4a is provided with two series of differentially detectable markings 6 and 7, the separation distance between the markings 6 being different from the separation distance between the markings 7, and the latter being slightly greater. In turn, the sheet 4b is also provided with two series of differentially detectable markings 8 and 9, the separation distance between the markings 8 being different from the separation distance between the markings 9. In the example depicted, the separation distance between the markings 6 and 8 of the sheets 4a and 4b, respectively, and between the markings 7 and 9 of said sheets 4a and 4b, respectively, is the same.

This variant of the process is also different from the variant of FIG. 1 in that the detection means 5 and 5′ are suitable for distinguishing among the detected markings those corresponding to a predetermined or pre-programmed pattern, said markings being the only ones automatically triggering the performance of the operation of transversely cutting the body 2a of bag. In the particular example, the detection of the markings 6 or of the markings 8 is what triggers in this case the cutting operation downstream from the location of the detection means 5 or 5′.

As is observed in FIG. 2, despite the fact that the markings 7 and 9 (the latter not visible in the longitudinal portion 2b of the body of bag 2a) are located in the central portion of the longitudinal portion 2b from which the bag 1 will be made, do not negatively change the appearance of the bag 1, since they are invisible to the human eye.

If changing the length of the bags 1 to be made is desired, it is only necessary to pre-select the markings 7 or 9 as the predetermined patterns so that the cutting operation of the body of bag 2a is performed once such markings have been recognized by the detection means 5 or 5′.

Alternatively, the sheets 4a and 4b can be provided with markings 6 regularly distributed along their length and separated from one another a distance lesser than the length of the bags to be made.

FIG. 4 illustrates a longitudinal portion 2b obtained by cutting a body of bag 2a (not depicted) the total length of which is a multiple of the separation distance between every two consecutive markings 6.

To obtain the longitudinal portions 2b with the desired length, it is only necessary to provide the detection means 5 or 5′ with counting means and a processing unit, such that the cutting operation is performed only when the detection means 5 or 5′ detect the consecutive passage of a predetermined number of markings 6 or 8.

For the purpose of not breaking the continuity of an image 18 with a length greater than that of two consecutive markings 6 or 8, it is preferable in this case to provide the sheets 4a and 4b with small images 18, suitable for not detracting from the final finish of the bag 1 regardless of the location of the transverse cutting of the body of bag 2a from which the bag 1 will be manufactured.

According to other contemplated variants, suitable for manufacturing bags 1 with two sheets 4a and 4b, each one applied on one of the sides of the tubular mesh 3, the distribution of the markings 6 along one of the sheets 4a can be different from the distribution of the markings 8 along the other sheet 4b.

Only one of the sheets can be provided with more than one series of markings.

Likewise, both sheets can be provided with more than one series of markings, the markings of one series being equal or different from one another in arrangement (different distances between consecutive markings), in makeup (printed with different inks) and/or in configuration with respect to the markings of another series in the same sheet.

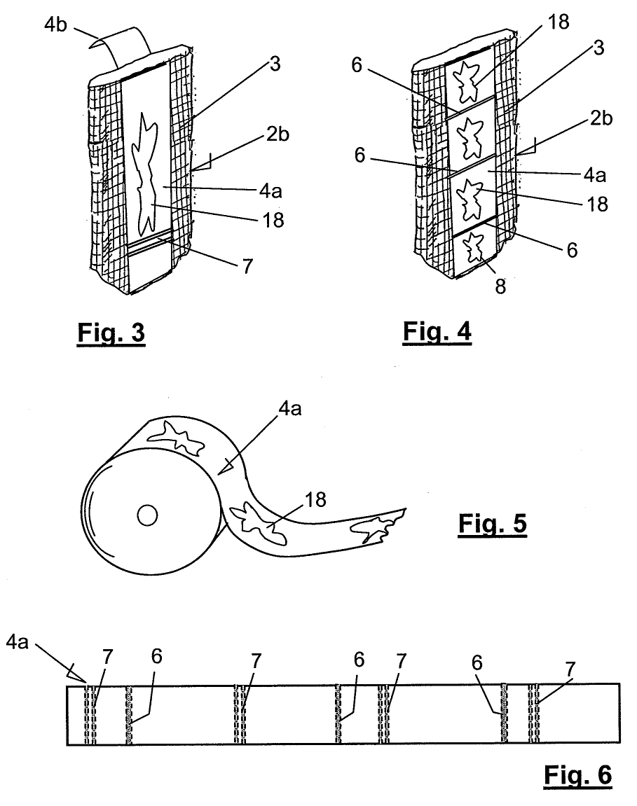

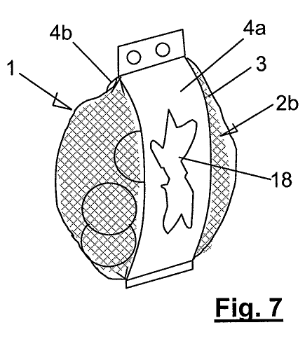

In addition, the possibility of supplying slightly different lengths each one of the sheets 4a and 4b in a controlled manner by means of the markings provided in the sheets 4a and 4b allows, especially when the process includes the operation of forming a body of bag 2a, as shown in FIGS. 1 and 2, obtaining longitudinal portions 2b from a body of bag 2a according to FIG. 3. In said FIG. 3 the result of supplying a length of sheet 4b greater than the length of sheet 4a can be seen. During the formation of the body of bag 2a, part of the sheet 4b, having a longer length than that of the section of associated tubular mesh 3, is applied but is not attached to the mentioned tubular mesh 3 and is stacked on said tubular mesh 3, generally in a zigzag fold. When the cutting operation occurs, if the mentioned section of excess sheet 4b is located adjacent to the transverse cutting, the end of the sheet 4b is free, projecting from the longitudinal portion 2b of the body of bag 2a and being able to serve for subsequent operations in the finish of the bag, for example for example for making an auxiliary element such as a handle.

The sheets 4a and 4b are preferably formed by two superimposed bands, the inner band of which is intended to be applied on the tubular mesh 3, whereas the outer band is intended to be exposed outside the finished bag, and the markings 6, 7, 8 and 9 are printed on the inner face of the outer band. Furthermore, the mentioned inner face of the outer band is provided with a print carried out with an ink not transparent to visible light, superimposed on said markings 6, 7, 8 and 9.

FIG. 5 is perspective view of a reel of a sheet 4a applicable for carrying out the method according to FIGS. 1 and 2.

FIG. 6 is a plan view of a section of sheet 4a according to the invention, provided with a first series of markings 6 and with a second series of markings 7. Despite the fact that the markings are configured like transverse strips, it has been verified that said markings can even be formed by corporate logos or other types of graphics or by business identification, such that as well as serving to trigger operations such as a transverse cutting operation when they are detected, they can also advantageously serve to verify the authenticity of a product and prevent fraudulent copies thereof.

1. A process for the continuous production of mesh bags (1), comprising the operation of cutting longitudinal portions (2b) from a body of bag (2a) formed by a longitudinal section of flattened tubular mesh (3) and a longitudinal section of at least one flexible sheet (4a, 4b), longitudinally applied and attached to one of the faces of said flattened tubular mesh, wherein prior or subsequent to application on the mesh, the flexible sheet is passed through detection means (5, 5′); in that said flexible sheet is provided with a plurality of markings (6, 7, 8, 9) distributed along its length, transparent to visible light and luminescent upon being radiated with ultraviolet or infrared light; in that the detection means are suitable for emitting ultraviolet or infrared light to detect the passage through the detection field (10) of a section of flexible sheet provided with one of the markings; and in that the detection of one of said markings automatically triggers the performance of the operation of transversely cutting the continuous body of bag into a length corresponding to that of a bag.

2. The process according to claim 1, wherein the body of bag (2a) comprises two flexible sheets (4a and 4b), longitudinally applied on respective faces of the flattened tubular mesh (3), in that both sheets are provided with a plurality of markings (6, 8) distributed along their length, transparent to visible light and luminescent upon being radiated with ultraviolet or infrared light and in that both sheets are passed through the detection field of respective detection means (5, 5′).

3. The process according to claim 2, wherein the distribution of the markings (6) along one of the sheets (4a) is different from the distribution of the markings (8) along the other sheet (4b).

4. The process according to claim 1, wherein the detection means (5, 5′) are suitable for distinguishing among the detected markings those corresponding to a predetermined or pre-programmed pattern, said markings being the only ones automatically triggering the performance of the operation of transversely cutting the body of bag.

5. The process according to claim 1, wherein the markings in at least one of the sheets (4a) are distributed in series, the markings (6, 7) of each series being equal, equidistant from one another and differentially detectable with respect to the markings of the other series.

6. A mesh bag made according to the process of claim 1.

7. A flexible windable sheet (4a), applicable for making transpirable bags, such as mesh bags, the sheet comprising a plurality of markings (6, 7), distributed along a length of the sheet, transparent to visible light and luminescent upon being radiated with ultraviolet or infrared light.

8. The sheet (4a) according to claim 7, wherein the markings (6, 7) are distributed in one or several series, the markings of each series being equal, equidistant from one another and differentially detectable with respect to the markings of the other series.

9. The manufacture of a mesh bag, comprising;
providing a longitudinal and tubular section of mesh:
providing a longitudinal section of sheet the sheet comprising a plurality of markings distributed along a length of the sheet, transparent to visible light and luminescent upon being radiated with ultraviolet or infrared light;
applying and attaching the sheet to one side of the longitudinal and tubular section of mesh.
